(19) United States
(12) Patent Application Publication
(10) Pub. No.: US 2011/0192687 A1
(43) Pub. Date: Aug. 11, 2011

(54) Handle mount for brake lever of wheeled cycle

(75) Inventor: Lynn Allan Miles, Taichung (TW)

(73) Assignee: Elf Performance System Co., Ltd.

(21) Appl. No.: 12/658,323

(22) Filed: Feb. 9, 2010

(51) Int. Cl. B60T 11/16; B62L 3/02

(52) U.S. Cl. 188/344

(57) ABSTRACT

A brake lever assembly includes a handle mount having a fluid reservoir formed in a lever housing, a cylinder engaged into the lever housing and having one or more apertures communicative with a bore of the cylinder and the fluid reservoir of the lever housing for receiving a piston, a brake handle pivotally coupling to the lever housing with a pivot shaft and pivotally coupled to the piston with a link rod, the lever housing is made of lighter materials, such as plastic or composite materials with a molding process and with a decreasing manufacturing cost, the lever housing is molded onto the cylinder, or the cylinder is engaged into the lever housing after the lever housing is molded.

### BACKGROUND OF THE INVENTION

1. Field of the Invention

The present invention relates to a brake lever assembly for a hydraulic disc brake device of a wheeled cycle or motorcycle or bicycle, and more particularly to a brake lever assembly including a handle mount having an improved structure or mechanism for allowing the handle mount of the brake lever assembly to be made or manufactured with a lighter material and to be easily made or manufactured with a decreasing manufacturing cost.

2. Description of the Prior Art

Typical wheeled cycles or motorcycles or bicycles comprise a brake lever assembly attached to the handlebar of the bicycle for actuating or operating a brake device, such as a hydraulic disc brake device, and the brake lever assembly normally includes a handle mount having a clamp or attachment mechanism formed or provided thereon and configured to be fastened or attached to a handlebar of a bicycle which includes a hand grip for being grasped or held by the user, a brake device, such as a hydraulic disc brake device having a piston slidably engaged within the handle mount for actuating or operating the brake device of the bicycle, and a brake handle coupled to the piston for moving or actuating the piston to operate the brake device of the bicycle.

For example, U.S. Pat. No. 6,119,821 to Chiang, U.S. Pat. No. 6,336,327 to Noro et al., U.S. Pat. No. 6,883,647 to Wen, and U.S. Pat. No. 7,389,642 to Takizawa et al. disclose several examples of the typical brake lever assemblies of the bicycle each including a brake handle having an elongated finger grip and a transverse elongated mounting arm attached to a handle mount for pivotal movement about a fixed axis, and for operatively connecting a lever to a piston that is slidably contained in a master cylinder of the handle mount.

Normally, the handle mount is made of cast steel or materials and formed by a molding or casting process, and is then required to be drilled or machined with a passage or chamber therein for forming a master cylinder of the hydraulic disc brake device and for slidably receiving a piston therein.

However, it will be difficult to precisely or suitably form the passage or chamber or master cylinder in the handle mount and to snugly fit the piston in the master cylinder of the handle mount, and it requires a lot of specially trained workers and a great working time to drill or machine the passage or chamber or master cylinder in the handle mount. Furthermore, the cast steel or materials are heavy and may also greatly increase the weight of the handle mount for the bicycle.

The present invention has arisen to mitigate and/or obviate the afore-described disadvantages of the conventional brake lever assemblies for hydraulic disc brake devices.

### SUMMARY OF THE INVENTION

The primary objective of the present invention is to provide a brake lever assembly including a handle mount having an improved structure or mechanism for allowing the handle mount of the brake lever assembly to be made or manufactured with a lighter material, such as the plastic material, the composite material or the like, and to be easily made or manufactured with a decreasing manufacturing cost.

In accordance with one aspect of the invention, there is provided a brake lever assembly comprising a handle mount including a lever housing, and including a chamber formed in the lever housing, and including a fluid reservoir formed therein and communicative with the chamber of the lever housing, at least one cover member attached onto the lever housing for enclosing the fluid reservoir of the lever housing, a cylinder engaged into the chamber of the lever housing and including a bore formed therein and including at least one aperture formed therein and communicative with the bore of the cylinder and the fluid reservoir of the lever housing, a spring biasing member and a piston engaged into the bore of the cylinder, a brake handle including a finger grip bar and a mounting arm connected at a connected portion, and including a pivot hole formed in the connected portion of the brake handle for receiving a pivot shaft and for pivotally coupling to the lever housing with the pivot shaft, and the mounting arm including a free end, and a link rod including a first end pivotally coupled to the piston, and including a segment coupled to the free end of the brake handle.

The lever housing of the handle mount is preferably made of lighter materials, such as the plastic materials, the composite materials or the like for suitably decreasing the weight of the handle mount for the bicycle and for allowing the handle mount of the brake lever assembly to be easily made or manufactured with a decreasing manufacturing cost.

The handle mount includes a retaining ring engaged with the lever housing and the cylinder for solidly and stably locking or securing and retaining the cylinder in the chamber of the lever housing.

The lever housing of the handle mount is preferably injected or molded onto the cylinder with the light weight materials, and the cylinder may be made with the stronger or heavier materials. The first end of the link rod is preferably a ball-shaped or universal joint.

The brake handle includes a pivot opening formed in the free end of the mounting arm, and a pole pivotally fitted into the pivot opening of the mounting arm and including a screw hole formed in the pole, and the segment of the link rod is a threaded segment for engaging with the screw hole of the pole and for adjusting the mounting arm of the brake handle relative to the piston and the lever housing.

The brake handle includes a slot formed in the mounting arm for forming two flaps, and the pivot opening of the mounting arm is extended through the flaps for receiving and engaging with the pole and for pivotally or rotatably coupling to the piston with the link rod.

The handle mount includes a compartment formed in the lever housing and defined between two walls and communicative with the chamber of the lever housing, and includes an orifice extended through the walls and intersecting or communicative with the compartment of the handle mount for receiving or engaging with the pivot shaft.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial exploded view of a brake lever assembly in accordance with the present invention;

FIG. 2 is a perspective view of the brake lever assembly;

FIG. 3 is a partial cross sectional view illustrating a handle mount of the brake lever assembly;

FIG. 4 is a partial exploded and cross sectional view illustrating the other arrangement of the brake lever assembly; and

FIG. 5 is a further partial cross sectional view illustrating the formation of the handle mount for the brake lever assembly for the bicycle.

### DETAILED DESCRIPTION OF THE PREFERRED EMBODIMENT

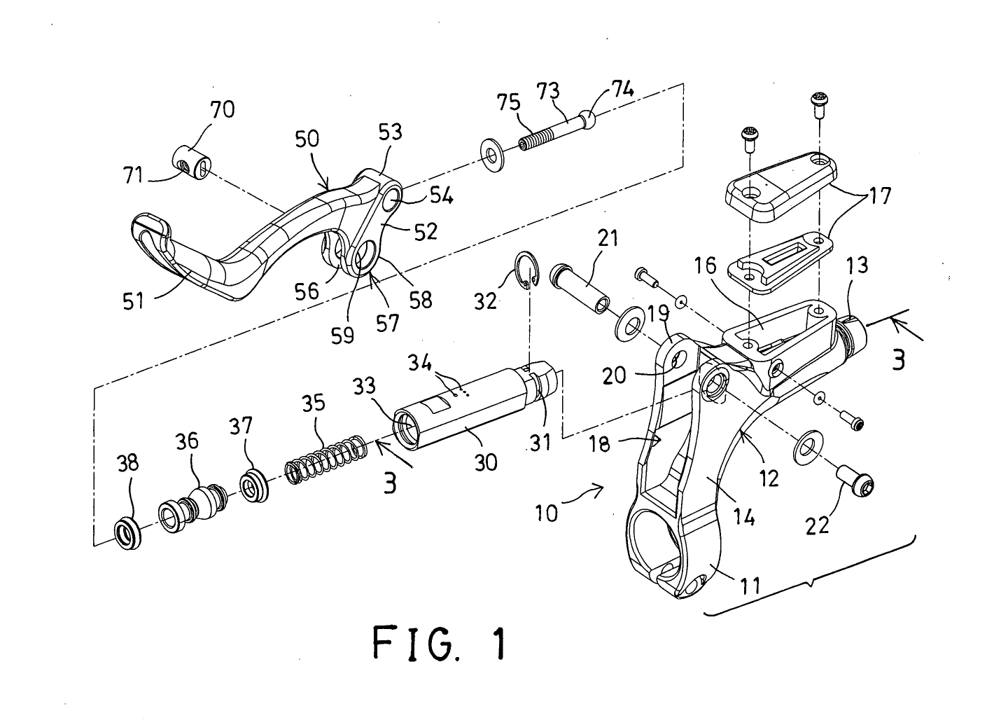

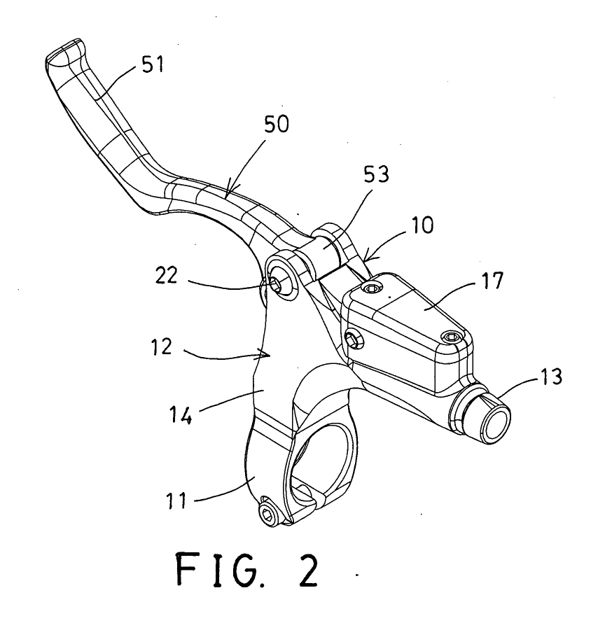

Referring to the drawings, and initially to FIGS. 1-3, a brake lever assembly in accordance with the present invention comprises a handle mount 10 including a clamp or attachment mechanism 11 formed or provided thereon and configured to be fastened or attached to a handlebar of a wheeled cycle (not shown), such as motorcycle, bicycle or the like which includes a hand grip (not shown) for being grasped or held by the user, the handle mount 10 includes a hollow L-shaped lever housing 12 having an integrally formed nose cone 13 and post 14, and includes a passage or chamber 15 formed therein and substantially parallel to the nose cone 13 of the lever housing 12, and includes a fluid reservoir 16 formed therein, such as formed in the upper portion of the lever housing 12 and communicative with the passage or chamber 15 of the lever housing 12 for receiving a fluid, such as a hydraulic fluid therein.

One or more (such as two) cover members 17 may further be provided and engaged or attached or mounted onto the lever housing 12 for enclosing the fluid reservoir 16 of the lever housing 12 and for suitably or sealingly retaining or containing the hydraulic fluid within the fluid reservoir 16 of the lever housing 12. The lever housing 12 of the handle mount 10 further includes a space or compartment 18 formed therein and formed or defined between two side walls 19 and communicative with the chamber 15 of the lever housing 12, in which the walls 19 each include an orifice 20 formed therein, and the orifices 20 of the walls 19 are coaxial, or the orifice 20 is extended through the walls 19 of the handle mount 10 and intersecting or communicative with the compartment 18 of the handle mount 10 for pivotally or rotatably coupling or attaching or mounting a pivot shaft 21, and one or more fasteners 22 may further be provided and engaged with the pivot shaft 21 and the lever housing 12 for solidly or stably attaching or mounting or securing the pivot shaft 21 to the lever housing 12.

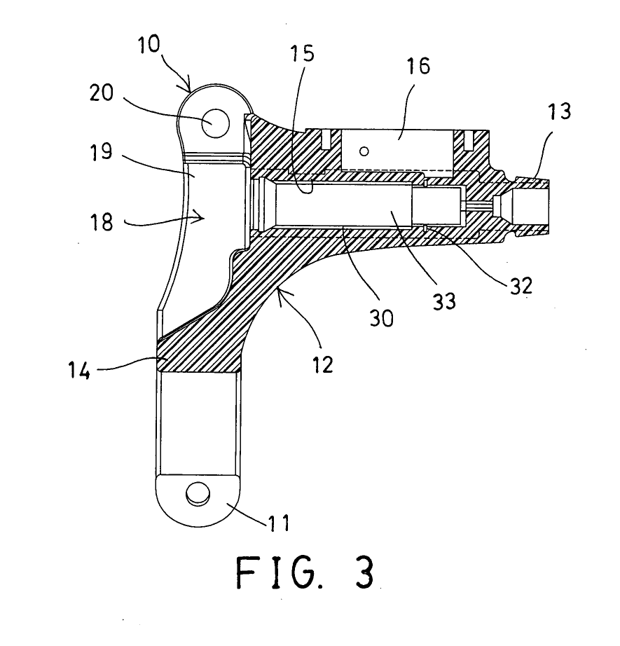

A cylinder 30 is fitted or molded or engaged or attached or mounted into the chamber 15 of the lever housing 12, and includes a peripheral slot 31 formed in the outer peripheral portion thereof for engaging with a clamping or retaining ring 32 which is engaged with the lever housing 12 (FIG. 3) for solidly or stably attaching or mounting or securing the cylinder 30 in the chamber 15 of the lever housing 12. The cylinder 30 includes a bore 33 formed therein, and includes one or more apertures 34 formed therein and communicative with the bore 33 of the cylinder 30, and also communicative with the fluid reservoir 16 and/or the chamber 15 of the lever housing 12 for allowing the hydraulic fluid to flow between the bore 33 of the cylinder 30 and the fluid reservoir 16 of the lever housing 12.

A spring biasing member 35 is disposed or engaged into the bore 33 of the cylinder 30, a piston 36 and one or more washers or gaskets 37, 38 are slidably engaged within the bore 33 of the cylinder 30 for making a fluid tight seal between the cylinder 30 and the piston 36, and for selectively forcing the hydraulic fluid to flow into the fluid reservoir 16 of the lever housing 12, or for selectively drawing the hydraulic fluid to flow from the fluid reservoir 16 of the lever housing 12 into the bore 33 of the cylinder 30. The spring biasing member 35 is engaged with the piston 36 and compressible by the piston 36 for biasing or forcing the piston 36 to move backwardly to the original position when the piston 36 is not forced onto or against the spring biasing member 35.

A brake handle 50 includes a finger grip bar 51 configured to be comfortably embraced by the fingers of a rider and an integrally formed or connected mounting arm 52, in which the finger grip bar 51 and the mounting arm 52 are connected at their proximal ends or at a connected portion 53; and includes a pivot hole 54 formed in the finger grip bar 51 and/or the mounting arm 52, or formed in the proximal ends or connected portion 53 of the finger grip bar 51 and the mounting arm 52 for receiving or engaging with the pivot shaft 21, and further includes a gap or slot 56 formed in the other end or free end 57 of the mounting arm 52 for forming or defining two flaps 58, and a pair of coaxial pivot openings 59 extended through the flaps 58 of the mounting arm 52.

A pole 70 is pivotally or rotatably engaged or fitted into the pivot openings 59 of the flaps 58 of the mounting arm 52, and includes a screw hole 71 formed therein and aligned with or communicative with the slot 56 of the mounting arm 52. A link rod 73 includes a ball-shaped or universal joint 74 formed or provided on one end or first end 74 thereof and pivotally or rotatably coupled to the piston 36, and includes a threaded segment 75 formed or provided on the other end thereof for threading or engaging with the screw hole 71 of the pole 70 and for coupling the other end or free end 57 of the mounting arm 52 of the brake handle 50 to the piston 36, and for adjusting or calibrating the other end or free end 57 of the mounting arm 52 of the brake handle 50 toward or away from or relative to the piston 36 and the lever housing 12.

In operation, the other end or free end 57 of the mounting arm 52 of the brake handle 50 may be moved or adjusted toward or away from or relative to the piston 36 and the lever housing 12 by rotating the link rod 73 relative to the pole 70 and the mounting arm 52 of the brake handle 50 in order to adjust the finger grip bar 51 and the brake handle 50 relative to the lever housing 12 and the hand grip of the handlebar and thus for adjusting the actuation or operation to the piston 36, and thus for allowing the finger grip bar 51 of the brake handle 50 to be easily held or grasped or operated by the rider to actuate or operate or move the piston 36 along the bore 33 of the cylinder 30 and to suitably operate a brake device, such as a hydraulic disc brake device for the bicycle (not shown).

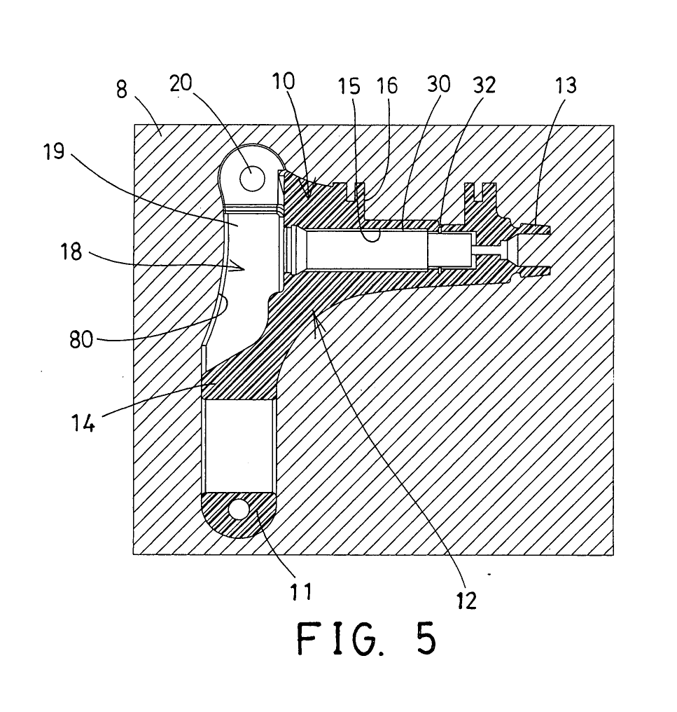

As shown in FIG. 5, a mold device 8 includes a mold cavity 80 formed therein for forming the lever housing 12 of the handle mount 10, and the cylinder 30 and/or the retaining ring 32 may first be engaged into the mold cavity 80 of the mold device 8, and then a material is then injected or introduced or molded into the mold cavity 80 of the mold device 8 for forming the lever housing 12 of the handle mount 10 and for allowing the lever housing 12 of the handle mount 10 and the cylinder 30 and/or the retaining ring 32 of the brake lever assembly to be easily and quickly made or manufactured and formed and retained together with the mold device 8, and with a decreasing manufacturing cost.

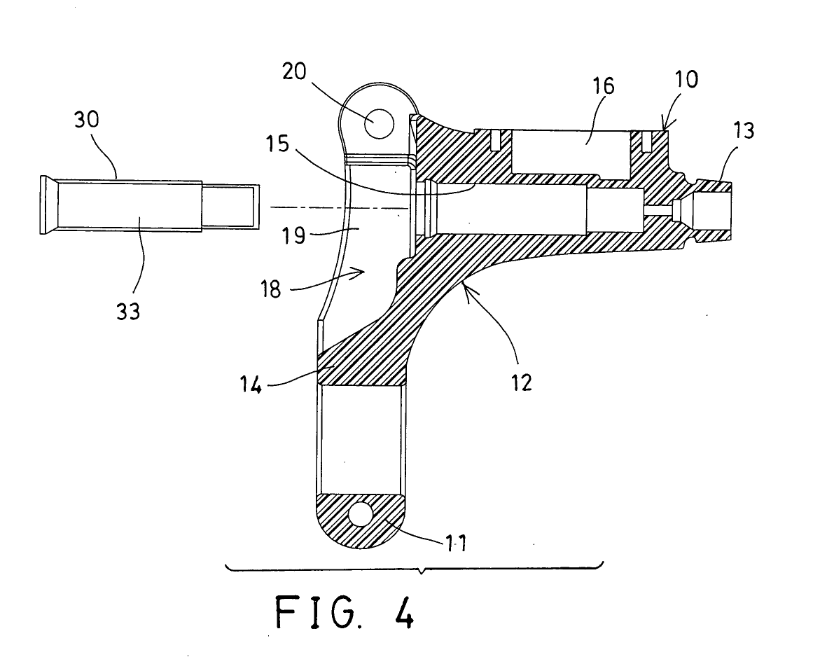

As shown in FIG. 3, the cylinder 30 and/or the retaining ring 32 may be easily and quickly made or retained in the lever housing 12 of the handle mount 10, and the lever housing 12 of the handle mount 10 may be easily and quickly made or manufactured and formed with the mold-injection or molding process. Alternatively, as shown in FIG. 4, the lever housing 12 of the handle mount 10 may also be first made or manufactured and formed with the mold device 8 and with the mold-injection or molding process, and the cylinder 30 and/or the retaining ring 32 may then be engaged into the chamber 15 of the lever housing 12.

It is to be noted that the cylinder 30 may be easily and quickly made or manufactured and formed with the metal or stronger or heavier materials and with various machining operations or procedures, and the lever housing 12 of the handle mount 10 may be easily and quickly made or manufactured and formed with or onto the cylinder 30 and/or the retaining ring 32 with the lighter materials, such as the plastic materials, glass or carbon fiber materials or other composite materials, or the like and with the mold-injection or molding process, and thus for allowing the weight of the handle mount 10 and the bicycle to be greatly reduced or decreased, and it is not required a lot of specially trained workers and a great working time to form or make the cylinder 30 and/or the retaining ring 32.

It is further to be noted that the lever housing 12 of the handle mount 10 may not be made or manufactured and formed with the lighter materials, such as the plastic materials, glass or carbon fiber materials or other composite materials, or the like, which may not be machined or drilled to form the chamber 15 in the lever housing 12 of the handle mount 10.

Accordingly, the brake lever assembly in accordance with the present invention includes a handle mount having an improved structure or mechanism for allowing the handle mount of the brake lever assembly to be made or manufactured with a lighter material and to be easily made or manufactured with a decreasing manufacturing cost.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A brake lever assembly comprising:
a handle mount including a lever housing, and including a chamber formed in said lever housing, and including a fluid reservoir formed therein and communicative with said chamber of said lever housing,
at least one cover member attached onto said lever housing for enclosing said fluid reservoir of said lever housing,
a cylinder engaged into said chamber of said lever housing and including a bore formed therein and including at least one aperture formed therein and communicative with said bore of said cylinder and said fluid reservoir of said lever housing,
a spring biasing member and a piston engaged into said bore of said cylinder,
a brake handle including a finger grip bar and a mounting arm connected at a connected portion, and including a pivot hole formed in said connected portion of said brake handle for receiving a pivot shaft and for pivotally coupling to said lever housing with said pivot shaft, and said mounting arm including a free end, and
a link rod including a first end pivotally coupled to said piston, and including a segment coupled to said free end of said brake handle.

2. The brake lever assembly as claimed in claim 1, wherein said lever housing of said handle mount is made of plastic materials.

3. The brake lever assembly as claimed in claim 1, wherein said lever housing of said handle mount is made of composite materials.

4. The brake lever assembly as claimed in claim 1, wherein said handle mount includes a retaining ring engaged with said lever housing and said cylinder for securing said cylinder in said chamber of said lever housing.

5. The brake lever assembly as claimed in claim 1, wherein said lever housing of said handle mount is molded onto said cylinder.

6. The brake lever assembly as claimed in claim 1, wherein said first end of said link rod is a ball-shaped or universal joint.

7. The brake lever assembly as claimed in claim 1, wherein said brake handle includes a pivot opening formed in said free end of said mounting arm, and a pole pivotally fitted into said pivot opening of said mounting arm and including a screw hole formed in said pole, and said segment of said link rod is a threaded segment for engaging with said screw hole of said pole and for adjusting said mounting arm of said brake handle relative to said piston and said lever housing.

8. The brake lever assembly as claimed in claim 7, wherein said brake handle includes a slot formed in said mounting arm for forming two flaps, and said pivot opening is extended through said flaps of said mounting arm for receiving and engaging with said pole.

9. The brake lever assembly as claimed in claim 1, wherein said handle mount includes a compartment formed in said lever housing and defined between two walls and communicative with said chamber of said lever housing, and includes an orifice extended through said walls for engaging with said pivot shaft.
